(19) United States
(12) Patent Application Publication
(10) Pub. No.: US 2018/0115253 A1
(43) Pub. Date: Apr. 26, 2018

(54) IMPROVEMENTS IN OR RELATING TO ELECTRICAL ASSEMBLIES

(71) Applicant: General Electric Technology GmbH, Baden (CH)

(72) Inventors: Robert Stephen WHITEHOUSE, Stafford (GB); Robin GUPTA, Stafford, Staffordshire (GB); Andrzej ADAMCZYK, Stafford (GB)

(73) Assignee: General Electric Technology GmbH, Baden (CH)

(21) Appl. No.: 15/559,339

(22) PCT Filed: Mar. 17, 2016
(86) PCT No.: PCT/EP2016/055893

§ 371 Date: Sep. 18, 2017

(30) Foreign Application Priority Data
Mar. 18, 2015 (EP) 15275075.8

(51) Int. Cl. H02M 7/483

(52) U.S. Cl. CPC H02M 7/483; H02M 2001/325

(57) ABSTRACT

An assembly including a converter including first and second DC terminals connectable to the DC network and between which extends a converter limb. Each converter limb includes first and second portions separated by an AC terminal. Each portion includes a switching element for normal operation and a switching element and energy absorber for a bypass mode. The bypass mode causes current to bypass the energy absorber in the limb portion and flow through the energy absorber. The assembly also includes an AC circuit breaker which is openable to isolate the converter from the network. The electrical assembly includes a control unit that is a programmed to operate the energy absorption module within the converter in its bypass mode and following a DC fault to initiate opening of the AC circuit breaker then to operate in absorption mode to remove DC fault current within an augmented current path.

### FIELD OF INVENTION

This invention relates to an electrical assembly for interconnecting AC and DC electrical networks, and to an electrical power transmission network comprising a plurality of interconnected electrical assemblies, at least one of which is a said foregoing electrical assembly.

### BACKGROUND OF THE INVENTION

In electrical power transmission networks alternating current (AC) power is typically converted to direct current (DC) power for transmission via overhead lines and/or under-sea cables. This conversion removes the need to compensate for the AC capacitive load effects imposed by the transmission line or cable and reduces the cost per kilometre of the lines and/or cables, and thus becomes cost-effective when power needs to be transmitted over a long distance.

Converters are used to convert between AC power and DC power.

### BRIEF DESCRIPTION

According to a first aspect of the invention there is provided an electrical assembly, for interconnecting AC and DC electrical networks, comprising: a converter to transfer power between the AC and DC electrical networks, the converter including first and second DC terminals connectable to the DC electrical network and between which extends at least one converter limb, the or each converter limb including first and second converter limb portions which are separated by an AC terminal, each converter limb portion including a primary switching element operable to facilitate power transfer between the corresponding AC and DC terminals during normal operation of the converter, at least one converter limb portion within the or each converter limb further including an energy absorption module including a secondary switching element and an energy absorber, the or each energy absorption module being operable in a bypass mode in which the secondary switching element causes current flowing through the corresponding converter limb portion to bypass the energy absorber and in an absorption mode in which the secondary switching element causes current flowing through the corresponding converter limb portion to flow through the energy absorber; an AC circuit breaker arranged in use between the AC terminal of the or each converter limb and the AC electrical network, the AC circuit breaker being selectively openable to electrically isolate the converter from the AC electrical network; and a control unit operatively associated with the converter and the AC circuit breaker, the control unit being programmed during normal operation of the converter to operate the or each energy absorption module within the converter in its bypass mode, and the control unit being programmed following occurrence of a DC fault to (i) initiate opening of the AC circuit breaker to electrically isolate the converter from the AC electrical network and then (ii) switch the or each energy absorption module to operate in its absorption mode to remove a DC fault current trapped within an augmented DC fault current path created by the isolated converter and the DC electrical network.

The inclusion of a control unit programmed during normal operation of the converter to operate the or each energy absorption module in its bypass mode conveniently avoids additional and undesirable losses from the power being transferred between the AC and DC terminals.

In the meantime having a control unit which is programmed, following occurrence of a DC fault, to initiate opening of an AC circuit breaker begins the process of removing the source of a high and potentially damaging DC fault current. Thereafter, the control unit being programmed to switch the or each energy absorption module into its absorption mode advantageously removes the DC fault current that remains even once the source of the fault current has been removed, i.e. even once the AC circuit breaker is fully open and the converter has been electrically isolated from the AC electrical network. This therefore helps to prevent such remaining DC fault current from continuing to freely circulate around an augmented DC fault current path which is unavoidably created when the converter is isolated from the AC electrical network.

Removing such remaining DC fault current is particularly beneficial since it reduces the time taken for the DC fault current to extinguish, i.e. become zero, and so minimises the delay before the process of recovering from the DC fault and restarting power transmission can begin. As a consequence the period of time for which users connected with the respective AC or DC electrical network are left without power is also reduced.

The aforementioned reduction in the delay before power transmission can begin again achieved by embodiments of the invention avoids the need to include costly and substantial DC circuit breakers, which for high voltage applications are still under development anyway.

In addition, embodiments of the invention provide the aforementioned improvement in the time taken to restart power transmission without the need to include a more complex primary switching element in an attempt to deal with the DC fault current but at the expense of increased component cost, volume and weight, as well as significant increased energy loss during normal operation of the converter.

Optionally the or each primary switching element includes a plurality of switching modules, each of which switching module includes a plurality of switches connected in parallel with an energy storage device, switching of the switches selectively directing current through the energy storage device or causing current to bypass the energy storage device whereby each switching module is able selectively to provide a voltage source, and whereby the plurality of switching modules together define a chain-link converter operable to provide a stepped variable voltage source.

Such an arrangement benefits electrical assemblies which include a particular class of converters that utilise stepped variable voltage sources to generate voltage waveforms that permit them to provide the aforementioned power transfer functionality between AC and DC networks.

The energy absorber may be capable of dissipating energy and/or storing energy.

An energy absorber of either form provides a ready way of removing the energy trapped within an associated DC electrical network during a DC fault condition.

In an embodiment of the invention the energy absorber is or includes one or more of the following: a resistor; a non-linear resistance; and a capacitor.

Each of the possible specified energy absorbers, either on its own or in combination, can be readily incorporated within a converter limb portion of a converter while desirably providing for the required selective removal of trapped energy from within an associated DC electrical network.

Optionally the secondary switching element is or includes a no-current switching device.

The inclusion of such a secondary switching element provides for a low cost and reliable switch to achieve the required switching into and out of circuit of the associated energy absorber within the energy absorption module.

The control unit may be programmed to switch the or each energy absorption module to operate in its absorption mode by providing the second switching element in the or each energy absorption module with a turn-off command and by continuing to operate the primary switching elements in the or each converter limb of the converter so that an alternating phase current flowing through each converter limb portion having an energy absorption module passes through a natural current zero.

The inclusion of such a control unit allows for utilisation of the alternating nature of the current flowing through each converter limb portion, i.e. the occurrence of natural current zeros during the transfer of power between the AC and DC terminals, to further permit the use of a simpler and less expensive secondary switching element that does not need to have a current switching capability, i.e. is a switching element which cannot be forced into a non-conducting state and can only be configured as such through natural commutation.

In an embodiment, the secondary switching element is or includes a current switching device.

The inclusion of a secondary switching element in the form of a current switching device allows such a secondary switching element to cause the current flowing through the converter limb portion to flow through the energy absorber at any time following the occurrence of a DC fault, and so avoids a reliance on the occurrence of natural current zeros in the current flowing through the converter limb portion to permit natural commutation of the secondary switching element. Greater flexibility is therefore available for operating such a secondary switching element so as to help ensure it desirably completes switching in order to cause current to flow through the energy absorber, e.g. before a protective AC circuit breaker within an associated AC electrical network completes its opening in response to the DC fault to isolate the converter from the AC electrical network and thereby protect the converter.

The or each converter limb portion including an energy absorption module may additionally include an isolation switch arranged to permit the permanent bypassing of current from flowing through the energy absorption module.

The inclusion of such an isolation switch desirably permits the permanent isolation of the energy absorption module from the converter limb portion, e.g. in the event of the energy absorption module becoming faulty.

The converter may include a plurality of converter limbs each of which is associated with a given phase of the converter.

The inclusion of a plurality of converter limbs extends the benefits of embodiments of the invention to electrical assemblies including multi-phase converters.

Optionally each converter limb portion includes an energy absorption module. Such an arrangement helps to remove the trapped DC fault current as quickly as possible.

The or each energy absorption module is in an embodiment arranged separately to the primary switching element in the corresponding converter limb portion.

According to a second aspect of the invention there is provided an electrical power transmission network comprising a plurality of interconnected electrical assemblies, at least one of which is an electrical assembly as described hereinabove.

The ability of a converter within one or more electrical assemblies to recommence power transmission quickly in the event of a DC fault condition, i.e. because the or each converter is able rapidly to dissipate the energy trapped in an associated DC electrical network in the event of such a fault, is particularly desirable, e.g. in relation to an interconnected power transmission network in the form of a HVDC grid, because in most instances many of the converters (and their associated AC electrical network) would otherwise be without power transmission for an extended period of time.

Moreover, in such electrical power transmission networks that include a plurality of electrical assemblies as described hereinabove, i.e. a plurality of converters, each such converter contributes to the removal of trapped energy from the associated DC electrical network in which the DC fault condition has arisen, and so there is a commensurate increase in the rate at which such energy is removed, and hence a proportional shortening of the delay before power transmission within the network can recommence.

### BRIEF DESCRIPTION OF THE DRAWINGS

There now follows a brief description of embodiments of the invention, by way of non-limiting example, with reference to the following drawings in which:

FIG. 1 shows a schematic view of an electrical assembly according to an embodiment of the invention;

FIG. 2A shows a first configuration of the electrical assembly shown in FIG. 1 in an initial phase following the occurrence of a DC fault;

FIG. 2B shows a second configuration of the electrical assembly shown in FIG. 1 in a subsequent phase following the occurrence of a DC fault; and

FIGS. 3A to 3 D show various conditions in a converter within the electrical assembly before and during the initial and subsequent phases illustrated in FIGS. 2A and 2 B.

### DETAILED DESCRIPTION

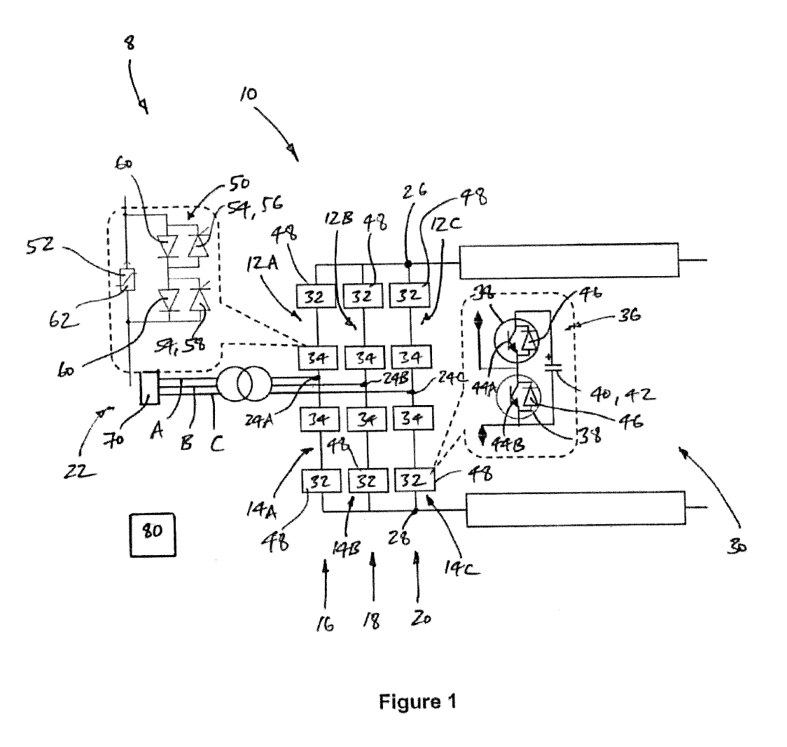

An electrical assembly according to an embodiment designated generally by reference numeral 8, as shown in FIG. 1.

The electrical assembly 8 includes a converter 10 which has three pairs of respective first and second converter limb portions 12A, 12B, 12C, 14A, 14B, 14C, each of which pair together defines a corresponding first, second, or third converter limb 16, 18, 20.

Each converter limb 16, 18, 20 is associated with a corresponding phase A, B, C of an alternating current (AC) electrical network 22 with which the converter 10 is, in use, connected.

In other embodiments (not shown) the converter of the invention may be intended for connection with an AC electrical network which has fewer than or more than three phases, such that the converter of the invention has a correspondingly fewer or greater number of converter limbs and corresponding converter limb portions.

Returning to the embodiment shown in FIG. 1, the respective pair of first and second converter limb portions 12A, 12B, 12C, 14A, 14B, 14C in each converter limb 16, 18, 20 share a common corresponding first, second or third AC terminal 24A, 24B, 24C via which they are connected with the aforementioned AC electrical network 22.

Each first and second converter limb portion 12A, 12B, 12C, 14A, 14B, 14C is also connected to a corresponding first or second DC terminal 26, 28 via which it is, in turn connected, in use, to a DC electrical network 30.

In the foregoing manner each converter limb 16, 18, 20 extends between the first and second DC terminals 26, 28, and includes corresponding first and second converter limb portions 12A, 12B, 12C, 14A, 14B, 14C which are separated by a corresponding first, second or third AC terminal 24A, 24B, 24C.

Meanwhile, each converter limb portion 12A, 12B, 12C, 14A, 14B, 14C includes a primary switching element 32 which is connected in series with an energy absorption module 34. In other embodiments of the invention, however, not all of the converter limb portions need necessarily include an energy absorption module although at least one converter limb portion in each converter limb should include such a module.

Each primary switching element 32 is operable to facilitate power transfer between the corresponding AC terminal 24A, 24B, 24C and corresponding first or second DC terminal 26, 28.

More particularly, in the embodiment shown each primary switching element 32 includes a plurality of switching modules 36 (only one or which is shown in FIG. 1). In turn, each switching module 36 includes a plurality of switches 38 that are connected in parallel with an energy storage device 40.

More particularly still, each switching module 36 includes a pair of switches 38 that are connected in parallel with an energy storage device 40, in the form of a capacitor 42, in a known half-bridge arrangement to define a 2-quadrant unipolar module. In the embodiment shown the switches 38 are first and second semiconductor devices 44A, 44B in the form of, e.g. respective Insulated Gate Bipolar Transistors (IGBTs), each which is connected in parallel with an anti-parallel diode 46.

It is, however, possible to use other semiconductor devices. In addition, in other embodiments of the invention one or more of the switching modules 36 may have a different configuration to that described above.

In the embodiment shown switching of the semiconductor devices 44A 44B, i.e. IGBTs, in each switching module 36 selectively directs current through the capacitor 42 or causes current to bypass the capacitor 42 such that each switching module 36 can provide a zero or positive voltage and can conduct current in two directions. In this manner the plurality of switching modules 36 within each primary switching element 32 together define a chain-link converter 48 that is operable, during normal operation of the converter 10, to provide a stepped variable voltage source.

In the meantime, each energy absorption module 34 includes a secondary switching element 50 and an energy absorber 52.

In each energy absorption module 34 the secondary switching element 50 is a no-current switching device 54, i.e. a switching device that cannot be forced into a non-conducting state and can only be configured as such through natural commutation to zero of the current flowing therethrough.

More particularly each secondary switching element 50 is defined by first and second series-connected thyristors 56, 58, each of which thyristor 56, 58 has an anti-parallel diode 60 connected in parallel therewith. Connecting the thyristors 56, 58 in series with one another reduces the individual switching voltage that each needs to support, but in other embodiments of the invention one or more secondary switching elements may be defined by a single thyristor.

In further embodiments of the invention one or more secondary switching elements 50 may be defined by a different no-current semiconductor switching device such as a mechanical switch or mechanical circuit breaker (which are opened only when the current passing therethrough is zero), or some other electronic switch.

In still further embodiments of the invention one or more of the secondary switching elements may instead include a current switching device in the form of, e.g. a current switching semiconductor switching device such as an IGBT or a current switching mechanical switching device.

Returning to the embodiment shown in FIG. 1, the energy absorber 52 is a surge arrestor 62 which defines a non-linear resistance. Such a surge arrestor 62 is able to absorb energy from current flowing therethrough and dissipate that energy in the form of heat.

Other types of energy absorber may, however, be used in embodiments of the invention, such as a resistor or capacitor. Indeed, any element capable of dissipating or storing energy could be used as, or as a part of, the energy absorber.

In addition to the foregoing the electrical assembly 8 includes an AC circuit breaker 70 which is arranged between the AC terminal 24A, 24B, 24C of each converter limb 16, 18, 20 and the AC electrical network 22. The AC circuit breaker 70 can be opened to electrically isolate the converter 10 from the AC electrical network 22.

The electrical assembly 8 still further includes a control unit 80 which is operatively associated with both the converter 10 and the AC circuit breaker 70.

The control unit 80 is programmed to control operation of the converter 10 and the AC circuit breaker 70, and more particularly is programmed in the following manner.

During normal operation of the converter 10, i.e. while the control unit 80 is controlling the plurality of switching modules 36 within each primary switching element 32 to function as a chain-link converter 48 to provide a stepped variable voltage source, the control unit 80 is programmed to operate each energy absorption module 34 in a bypass mode. More particularly, the control unit 80 closes the secondary switching element 50 in each corresponding energy absorption module 34 so as to cause the current flowing through each corresponding converter limb portion 12A, 12B, 12C, 14A, 14B, 14C to bypass the associated energy absorber 52 and thereby avoid the energy absorber 52 undesirably contributing to any conducting losses of the converter 12.

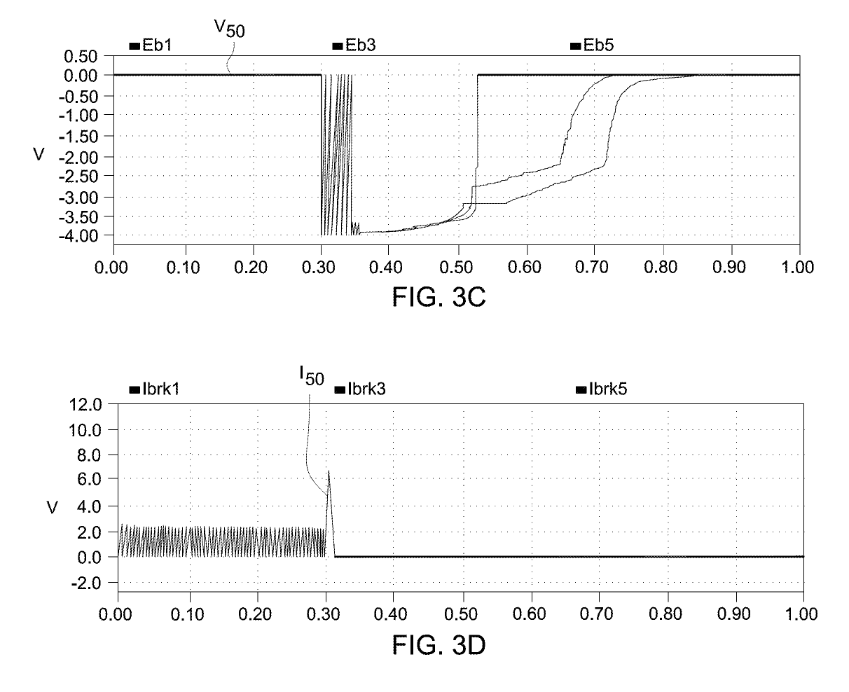

In the example shown in FIGS. 3A to 3D the converter 10 operates normally up until 300 ms. During such normal operation of the converter 10 the current I_{A}, I_{B}, I_{C} flowing from each phase A, B, C of the AC electrical network into the converter 10 (as shown in FIG. 3A) the current I₅₀ carried by each secondary switching element (as shown in FIG. 3D by way of example for the secondary switching element in each first converter limb portion 12A, 12B, 12C), and the DC current I_{DC} (as shown in FIG. 3B) and are all consistent with one another.

At the same time the voltage V₅₀ across each secondary switching element 50 is essentially zero, as shown in FIG. 3C, again by way of example for the secondary switching element in each first converter limb portion 12A, 12B, 12C.

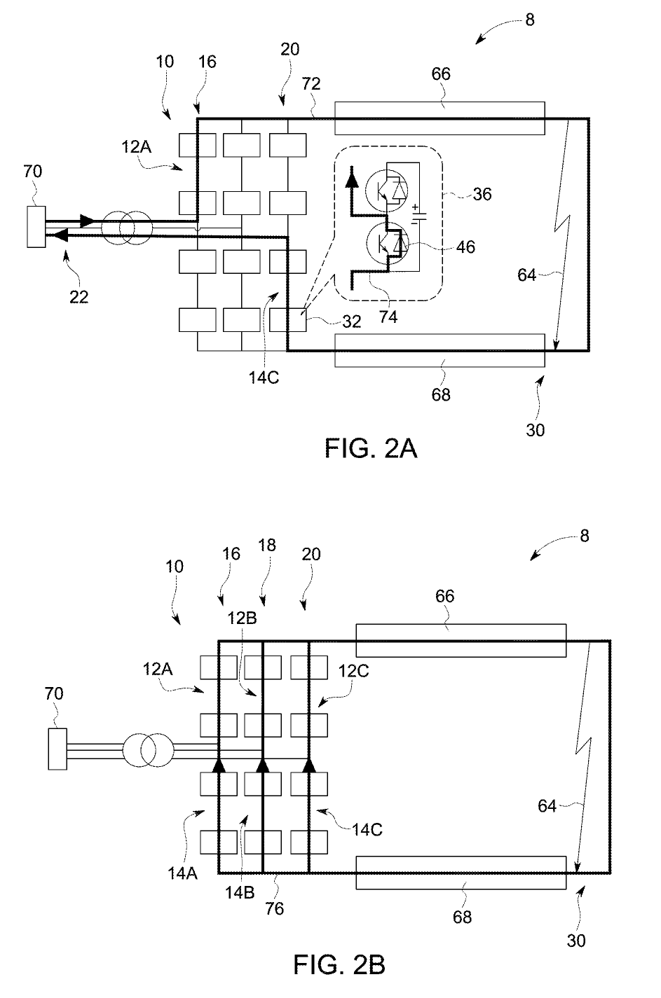

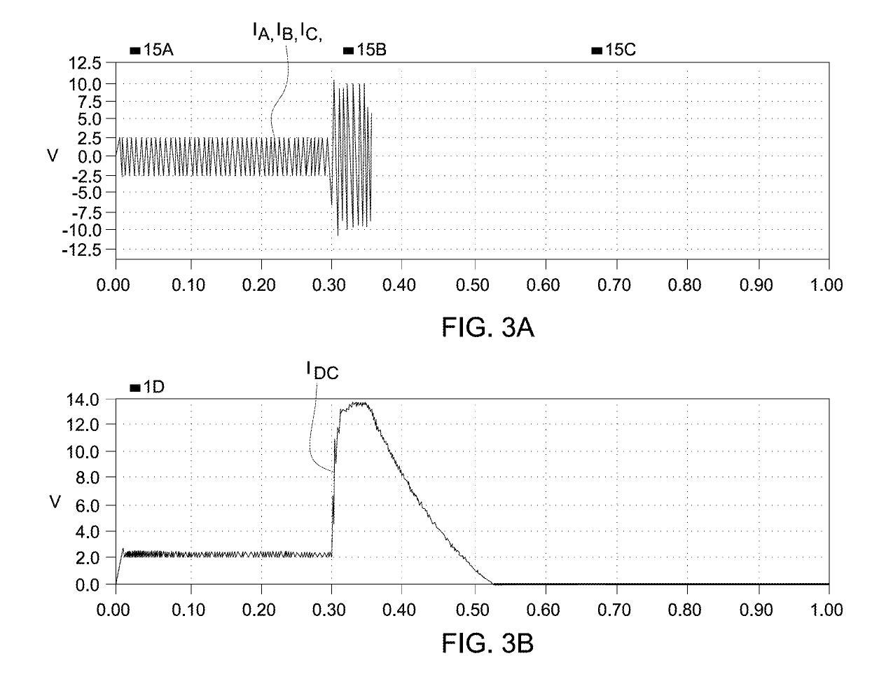

FIG. 2A illustrates a first configuration of the electrical assembly 8 in an initial phase immediately following the occurrence of a DC fault, e.g. at 300 ms, which gives rise to a DC fault condition. Such a DC fault may be a short circuit 64 between first and second DC transmission mediums 66, 68 (connected respectively to the first and second DC terminals 26, 28 of the converter 10) within the DC electrical network 30, although other types of DC fault may also occur.

Immediately after the short circuit 64 the control unit 80 is programmed to initiate opening of the protective AC circuit breaker 70 (in order to protect the converter 10 by isolating it from the AC electrical network 22), but in the time taken for the AC circuit breaker 70 to open, current I_{A}, I_{B}, I_{C} continues to flow, indeed a larger amount of current I_{A}, I_{B}, I_{C} flows, into the converter 10 from each phase A, B, C of the AC electrical network 22, as shown in FIG. 3A.

During this period of opening the aforementioned short circuit 64 gives rise to a DC fault current path 72 which is defined by the first and second DC transmission mediums 66, 68, together with the primary switching element 32 (and more particularly a current path portion 74 defined by the anti-parallel diode 46 associated with the second semiconductor device 44B within each switching module 36 of each primary switching element 32) and the corresponding energy absorption module 34, i.e. the secondary switching element 50 therein, within respective first and second converter limb portions 12A, 12B, 12C, 14A, 14B, 14C. The creation of such a DC fault current path 72 leads to a dramatic increase in the level of DC current I_{DC}, as shown in FIG. 3B.

The combination of first and second limb portions 12A, 12B, 12C, 14A, 14B, 14C which together define a part of the DC fault current path 72, e.g. the first limb portion 12A within the first converter limb 16 and the second converter limb portion 14C in the third converter limb 20 as shown in FIG. 2A, varies as the current I_{A}, I_{B}, I_{C} flowing in each phase A, B, C of the AC electrical network 22 continues to oscillate by virtue of the ongoing switching control of the primary switching elements 32 provided by the control unit 80.

Approximately 2 ms after occurrence of the short circuit 64 the control unit 80 provides the secondary switching element 50 (i.e. the first and second thyristors 56, 58 therein) within each energy absorption module 34 with a turn-off command, i.e. a command to open, so as to cause switching of each energy absorption module 34 into an absorption mode in which the current flowing through the associated converter limb portion 12A, 12B, 12C, 14A, 14B, 14C is diverted to flow instead through the corresponding energy absorber 52, i.e. the corresponding surge arrestor 62.

The control unit 80 continues to operate the primary switching elements 32 in each converter limb 16, 18, 20 of the converter 10 so that the no-current switching first and second thyristors 56, 58, i.e. the secondary switching elements 50, cease to conduct current when the associated alternating phase current I_{A}, I_{B}, I_{C} flowing therethrough passes through a natural current zero. At such a point the corresponding energy absorption module 34 is fully switched to operate in its energy absorption mode.

As a consequence of such a slight delay in experiencing a natural current zero, the secondary switching elements 50 in whichever combination of first and second converter limb portions 12A, 12B, 12C, 14A, 14B, 14C happens to be conducting when the short circuit occurs, e.g. those in the first limb portion 12A within the first converter limb 16 and the second converter limb portion 14C in the third converter limb 20 as shown in FIG. 2A, experience a spike in the current 150 flowing therethrough (as shown in FIG. 3D, by way of example, for the secondary switching element 50 in the first limb portion 12A of the first converter limb 16).

Following the complete turn off, i.e. opening, of each secondary switching element 50 and the resulting operation of the associated energy absorption module 34 in its absorption mode, the current I₅₀ flowing through each secondary switching element 50 drops to zero while the voltage V₅₀ thereacross increases. Nevertheless, as illustrated in FIG. 3C by way of example for a converter 10 rated at 640 kv (i.e. ±320 kV DC), the ohmic value of the energy absorber 52, i.e. the surge arrestor 62, is chosen so that each secondary switching element 50 is exposed only to a voltage of approximately 4 kV, such that the switching losses associated with each secondary switching element 50 are insignificant compared with the overall switching losses of the converter 10.

Around 60 ms after the short circuit 64 arises, the AC circuit breaker 70 has had sufficient time to open and the alternating phase currents I_{A}, I_{B}, I_{C} are prevented from flowing into the converter 10 from each phase A, B, C of the AC electrical network 22, as shown in FIG. 3A, i.e. the converter 10 is electrically isolated from the AC electrical network 22.

Following opening of the AC circuit breaker 70 the electrical assembly 8 adopts a second configuration during a subsequent phase following occurrence of a DC fault, as shown in FIG. 2B. In this second configuration the DC electrical network 30 is completely isolated from the AC electrical network 22 and an augmented DC fault current path 76 is created by the isolated converter 10 and the DC electrical network 30. More particularly the augmented DC fault current path 76 is defined by the first and second DC transmission mediums 66, 68 and the short circuit 64, together with each converter limb 16, 18, 20 within the converter 10.

Meanwhile, although a very significant source of DC fault current I_{DC} has been removed by opening the AC circuit breaker 70, i.e. none of the alternating phase currents I_{A}, I_{B}, I_{C} is able now to flow into the converter 10, and so the level of DC fault current I_{DC} has fallen significantly, as shown in FIG. 3B, the isolation of the converter 10 and DC electrical network 30 from the AC electrical network 22 unavoidably traps the remaining DC fault current I_{DC} within the aforementioned augmented DC fault current path 76 wherein it continues to circulate.

However, since each energy absorber 52, i.e. each surge arrestor 62, is now switched into circuit within each converter limb portion 12A, 12B, 12C, 14A, 14B, 14C, i.e. since each energy absorption module 34 is operating in its absorption mode, the remaining DC fault current I_{DC} is reduced to zero very rapidly as again shown in FIG. 3B.

Once the DC fault current I_{DC} is zero the process of recovering from the DC fault and restarting power transmission begins.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An electrical assembly, for interconnecting AC and DC electrical networks, comprising:
a converter to transfer power between the AC and DC electrical networks, the converter including first and second DC terminals connectable to the DC electrical network and between which extends at least one converter limb, the or each converter limb including first and second converter limb portions which are separated by an AC terminal, each converter limb portion including a primary switching element operable to facilitate power transfer between the corresponding AC and DC terminals during normal operation of the converter, at least one converter limb portion within the or each converter limb further including an energy absorption module including a secondary switching element and an energy absorber, the or each energy absorption module being operable in a bypass mode in which the secondary switching element causes current flowing through the corresponding converter limb portion to bypass the energy absorber and in an absorption mode in which the secondary switching element causes current flowing through the corresponding converter limb portion to flow through the energy absorber;
an AC circuit breaker arranged in use between the AC terminal of the or each converter limb and the AC electrical network, the AC circuit breaker being selectively openable to electrically isolate the converter from the AC electrical network; and
a control unit operatively associated with the converter and the AC circuit breaker, the control unit being programmed during normal operation of the converter to operate the or each energy absorption module within the converter in its bypass mode, and the control unit being programmed following occurrence of a DC fault to (i) initiate opening of the AC circuit breaker to electrically isolate the converter from the AC electrical network and then (ii) switch the or each energy absorption module to operate in its absorption mode to remove the energy trapped within an augmented DC fault current path created by the isolated converter and the DC electrical network.

2. The electrical assembly according to claim 1 wherein the or each primary switching element includes a plurality of switching modules, each of which switching module includes a plurality of switches connected in parallel with an energy storage device, switching of the switches selectively directing current through the energy storage device or causing current to bypass the energy storage device whereby each switching module is able selectively to provide a voltage source, and whereby the plurality of switching modules together define a chain-link converter operable to provide a stepped variable voltage source.

3. The electrical assembly according to claim 1 wherein the energy absorber is capable of dissipating energy and/or storing energy.

4. The electrical assembly according to claim 3 wherein the energy absorber is or includes one or more of the following:
a resistor;
a non-linear resistance; and
a capacitor.

5. The electrical assembly according to claim 1 wherein the or each secondary switching element is or includes a no-current switching device.

6. The electrical assembly according to claim 5 wherein the control unit is programmed to switch the or each energy absorption module to operate in its absorption mode by providing the second switching element in the or each energy absorption module with a turn-off command and by continuing to operate the primary switching elements in the or each converter limb of the converter so that an alternating phase current flowing through each converter limb portion having an energy absorption module passes through a natural current zero.

7. The electrical assembly according to claim 1 wherein the or each secondary switching element is or includes a current switching device.

8. The electrical assembly according to claim 1 wherein the or each converter limb portion including an energy absorption module also additionally includes an isolation switch arranged to permit the permanent bypassing of current from flowing through the energy absorption module.

9. The electrical assembly according to claim 1 including a plurality of converter limbs each of which is associated with a given phase of the converter.

10. The electrical assembly according to claim 1 wherein each converter limb portion includes an energy absorption module.

11. The electrical assembly according to claim 1 wherein the or each energy absorption module is arranged separately to the primary switching element in the corresponding converter limb portion.

12. The electrical power transmission network comprising a plurality of interconnected electrical assemblies, at least one of which is an electrical assembly according to claim 1.
